(19) United States
(12) Patent Application Publication
(10) Pub. No.: US 2015/0077309 A1
(43) Pub. Date: Mar. 19, 2015

(54) IMAGE DISPLAY SYSTEM, SHEETLIKE DISPLAY TERMINAL, AND PORTABLE TERMINAL

(71) Applicant: Japan Display Inc., Tokyo (JP)

(72) Inventors: Hajime AKIMOTO, Tokyo (JP); Toshihiro SATO, Tokyo (JP)

(73) Assignee: Japan Display Inc.

(21) Appl. No.: 14/489,533

(22) Filed: Sep. 18, 2014

(30) Foreign Application Priority Data
Sep. 18, 2013 (JP) 2013-192688

(51) Int. Cl. G09G 5/12; G06F 3/14; G06F 1/32; G09G 5/00

(52) U.S. Cl. CPC G09G 5/12; G09G 5/005; G06F 3/1423; G06F 1/3218; G09G 2330/021; G09G 2360/08; G09G 2370/16
USPC 345/1.2

(57) ABSTRACT

In a state where an interface unit disposed on a rear surface of a portable terminal faces an interface unit disposed on a rear surface of a sheetlike display terminal, the portable terminal is put on the sheetlike display terminal. With this configuration, the portable terminal and the sheetlike display terminal are electrically connected to each other through the respective interfaces by capacitive coupling.

### CROSS-REFERENCE TO RELATED APPLICATIONS

The present application claims priority from Japanese application JP 2013-192688 filed on Sep. 18, 2013, the content of which is hereby incorporated by reference into this application.

### BACKGROUND OF THE INVENTION

1. Field of the Invention

The present invention relates to an image display system, a sheetlike display terminal, and a portable terminal.

2. Description of Related Art

JP 2013-008036 A discloses a technique in which an image acquired by a computer is displayed on a monitor separate from the computer. In JP 2013-008036 A, the computer and the monitor are electrically connected to each other by a USB (universal serial bus) cable, and data of the image is supplied to the monitor by the USB cable.

### SUMMARY OF THE INVENTION

Incidentally, it is general to carry a main portable terminal (for example, smartphone) frequently used, together with a sub portable terminal (for example, tablet terminal) having a display larger in size than the main portable terminal.

An advantage obtained by carrying the sub portable terminal in addition to the main portable terminal resides in that the image can be viewed on a screen larger to some degree. On the other hand, it is burdensome to carry two portable terminals in terms of weight.

Under the circumstances, it is conceivable that the sub portable terminal is replaced with a sheetlike display terminal having a display larger than that of the main portable terminal, the main portable terminal produces data of an image to be displayed on the sheetlike display terminal, and the data and an electric power are supplied to the sheetlike display terminal. This is because if the sub portable terminal is replaced with the sheetlike display terminal having no circuit for producing the data of the image, and no battery, the burden can be reduced in terms of the weight as compared with a case in which those two portable terminals are carried. Also, even in this case, the user can view the image on the larger screen to some degree.

It is desirable to carry out an electric connection between the main portable terminal and the sheetlike display terminal as conveniently as possible.

An object of the invention is to reduce a burden for viewing an image on a larger screen to some degree as compared with a case to carry one portable terminal and another portable terminal having a display larger than that of the one portable terminal.

In order to solve the above problem, according to the invention, there is provided an image display system, including: a portable terminal; and a sheetlike display terminal, in which the portable terminal includes: a power supply; a generation unit that generates pixel data representing an image to be displayed on the sheetlike display terminal; and a first interface unit that is used for transfer of signal with respect to the sheetlike display terminal, and transmission of an electric power based on the power supply to the sheetlike display terminal, in which the portable terminal transfers the pixel data to the sheetlike display terminal through the first interface unit, in which the sheetlike display terminal includes: a display unit that displays an image; a second interface unit that is used for transfer of a signal with respect to the portable terminal, and reception of the electric power from the portable terminal; and a display control unit that allows the image represented by the pixel data received through the second interface unit to be displayed on the display unit, on the basis of the electric power received through the second interface unit, and in which in a state where a first interface area corresponding to the first interface unit in a given surface of a housing of the portable terminal faces a second interface area corresponding to the second interface unit in a rear surface of an image display surface of the sheetlike display terminal, the portable terminal is put on the sheetlike display terminal so that the portable terminal and the sheetlike display terminal are electrically connected to each other through the first interface unit and the second interface unit.

In this configuration, a convex portion may be formed in one of the first interface area and the second interface area, a concave portion having a shape corresponding to a shape of the convex portion may be formed in the other of the first interface area and the second interface area, and the convex portion may be fitted into the concave portion so that the portable terminal is put on the sheetlike display terminal in a state where the first interface area faces the second interface area.

Also, the portable terminal and the sheetlike display terminal may be connected to each other through the first interface unit and the second interface unit by capacitive coupling or electromagnetic coupling to enable the signal to be transferred therebetween.

Also, the portable terminal and the sheetlike display terminal may be connected to each other through the first interface unit and the second interface unit by capacitive coupling to enable the electric power to be transferred therebetween.

Also, the portable terminal further may include a display that displays the image, and the given surface may be the rear surface of the image display surface of the housing of the portable terminal.

Also, at least one of the first interface unit and the second interface unit may include an attraction generation unit that generates an attraction force between the first interface unit and the second interface unit.

Also, the sheetlike display terminal may transmit format data representing a format required for the image to be displayed on the display unit to the portable terminal through the second interface unit, and the generation unit may generate the pixel data on the basis of the format data received through the first interface unit.

Also, the sheetlike display terminal may include a plurality of the second interface units, in a state where the first interface area faces the second interface area corresponding to any one of the plurality of second interface units, the portable terminal may be put on the sheetlike display terminal so that the portable terminal and the sheetlike display terminal are electrically connected to each other through the first interface unit and the any second interface unit, and the sheetlike display terminal may transmit the format signal corresponding to the second interface area that faces the first interface area to the portable terminal.

Also, the sheetlike display terminal may transmit data representing a reference power for allowing the image to be displayed on the display unit to the portable terminal through the second interface unit.

Also, the sheetlike display terminal may further include a monitor unit that monitors a voltage based on the electric power received through the second interface unit, and the sheetlike display terminal may transmit data indicating a change in the amount of electric power to be transmitted, to the portable terminal through the second interface unit according to the monitoring result of the monitor unit.

Also, the sheetlike display terminal may further include a secondary battery that stores the electric power received through the second interface unit, and the display control unit may allow the image represented by the pixel data to be displayed on the display unit on the basis of the electric power stored in the secondary battery if the electric connection between the portable terminal and the sheetlike display terminal is canceled.

Also, in order to solve the above problem, according to the invention, there is provided a sheetlike display terminal having a display unit that displays an image, the sheetlike display terminal including: a second interface unit that is used for receiving a data signal and an electric power from a portable terminal including a power supply, a generation unit that generates pixel data representing an image to be displayed on the sheetlike display terminal, and a first interface unit that is used for transmitting the pixel data and the electric power based on the power supply to the sheetlike display terminal; and a display control unit that allows the image represented by the pixel data received through the second interface unit to be displayed on the display unit, on the basis of the electric power received through the second interface unit, in which in a state where a first interface area corresponding to the first interface unit in a given surface of a housing of the portable terminal faces a second interface area corresponding to the second interface unit in a rear surface of an image display surface of the sheetlike display terminal, the portable terminal is put on the sheetlike display terminal so that the sheetlike display terminal is electrically connected to the portable terminal through the first interface unit and the second interface unit.

Also, in order to solve the above problem, according to the invention, there is provided a portable terminal including: a power supply; a generation unit that generates pixel data representing an image to be displayed on the sheetlike display terminal having a second interface unit used for receiving a signal and an electric power; and a first interface unit that is used for transmitting the pixel data and an electric power based on the power supply to the sheetlike display terminal, in which in a state where a first interface area corresponding to the first interface unit in a given surface of a housing of the portable terminal faces a second interface area corresponding to the second interface unit in a rear surface of an image display surface of the sheetlike display terminal, the portable terminal is put on the sheetlike display terminal so that the portable terminal is electrically connected to the sheetlike display terminal through the first interface unit and the second interface unit.

### BRIEF DESCRIPTION OF THE DRAWINGS

FIG. 1 is a diagram illustrating a configuration of an image display system according to this embodiment;

FIG. 2 is a diagram illustrating an interface unit provided in a portable terminal;

FIG. 3 is a diagram illustrating interface units provided in a sheetlike display terminal;

FIG. 4A is a diagram illustrating one example of a state in which the portable terminal and the sheetlike display terminal are electrically connected to each other;

FIG. 4B is a diagram illustrating another example of a state in which the portable terminal and the sheetlike display terminal are electrically connected to each other;

FIG. 5 is a diagram illustrating components of the portable terminal;

FIG. 6 is a diagram illustrating components of the sheetlike display terminal;

FIG. 7A is a diagram illustrating a configuration of the interface unit provided in the portable terminal;

FIG. 7B is a diagram illustrating the configuration of the interface unit provided in the portable terminal;

FIG. 8A is a diagram illustrating a configuration of the interface unit provided in the sheetlike display terminal;

FIG. 8B is a diagram illustrating the configuration of the interface unit provided in the sheetlike display terminal;

FIG. 9 is a diagram illustrating the operation of the portable terminal and the sheetlike display terminal when the portable terminal and the sheetlike display terminal are electrically connected to each other;

FIG. 10 is a diagram illustrating the operation of the portable terminal and the sheetlike display terminal when the portable terminal and the sheetlike display terminal are electrically connected to each other;

FIG. 11A is a diagram illustrating pixel data in a pixel format A;

FIG. 11B is a diagram illustrating pixel data in a pixel format B;

FIG. 12 is a diagram illustrating components of the sheetlike display terminal; and

FIG. 13 is a diagram illustrating components of the sheetlike display terminal.

### DETAILED DESCRIPTION OF THE INVENTION

Hereinafter, embodiments of the invention will be described in detail with reference to the accompanying drawings.

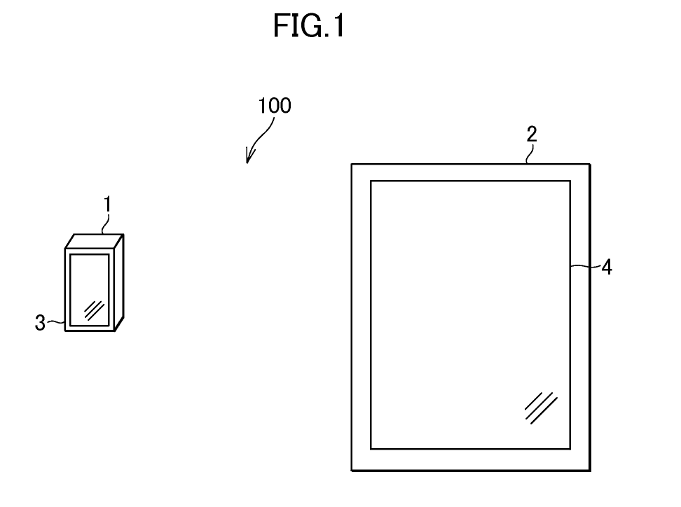

FIG. 1 is a diagram illustrating a configuration of an image display system 100 according to an embodiment of the invention. As illustrated in FIG. 1, the image display system 100 includes a portable terminal 1, and a sheetlike display terminal 2. The sheetlike display terminal 2 is used to view an image acquired by the portable terminal 1, and is carried by a user together with the portable terminal 1.

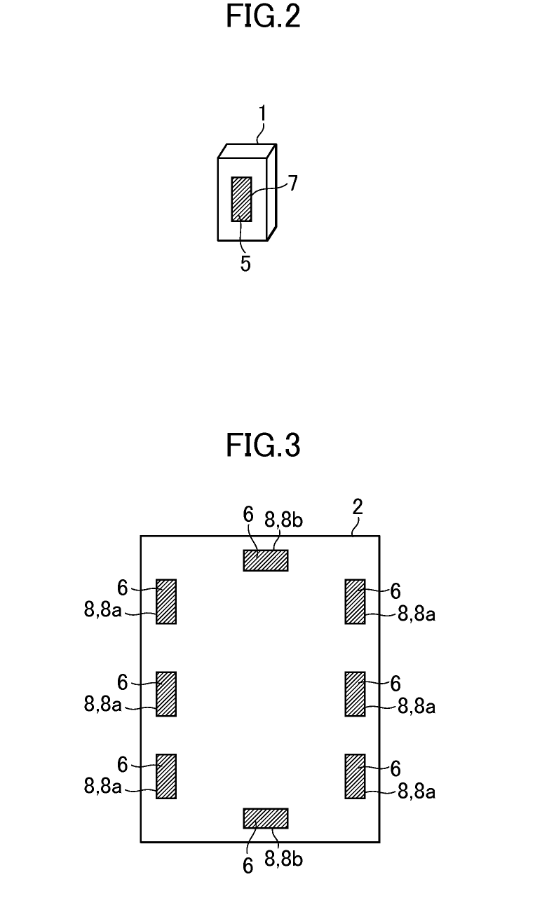

In this embodiment, the portable terminal 1 is realized as a cellular phone. The portable terminal 1 includes a liquid crystal display 3. A touch screen is realized by the liquid crystal display 3 and a touch pad not shown. Also, the portable terminal 1 includes an interface unit 7 for electrically connecting the portable terminal 1 to the sheetlike display terminal 2. FIG. 2 is a diagram illustrating the interface unit 7. The interface unit 7 has a rectangular shape, and is disposed in an interface area 5 in a rear surface of an image display surface (a surface having the liquid crystal display 3) of a housing for the portable terminal 1.

On the other hand, the sheetlike display terminal 2 includes a display 4 (an organic EL display in this example) larger than the liquid crystal display 3 (refer to FIG. 1). A touch screen is realized by the display 4, and a touch pad not shown. Also, the sheetlike display terminal 2 has eight interface units 8 for electrically connecting the sheetlike display terminal 2 to the portable terminal 1. FIG. 3 is a diagram illustrating the interface units 8. As illustrated in FIG. 3, the respective interface units 8 have the same shape as that of the interface unit 7 (refer to FIG. 3), and are disposed in eight interface areas 6 in the rear surface of the image display surface (a surface having the display 4). In this embodiment, the respective interface units 8 are arranged point-symmetrically with respect to a center of the sheetlike display terminal 2. In FIG. 3, the interface units 8 close to long sides of the sheetlike display terminal 2 are called “interface units 8a”, and the interface units 8 close to short sides of the sheetlike display terminal 2 are called “interface units 8b”.

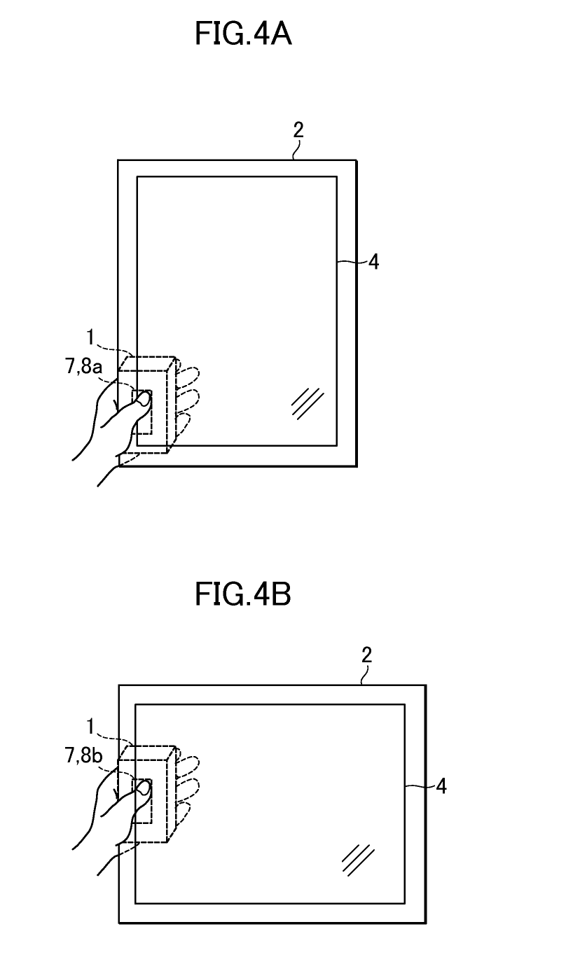

In the image display system 100, the portable terminal 1 and the sheetlike display terminal 2 are electrically connected to each other through the interface unit 7 and any interface unit 8 under a given condition. That is, when the portable terminal 1 is put on the sheetlike display terminal 2 (refer to FIGS. 4A and 4B to be described later) in a state where the interface area 5 (refer to FIG. 2) and any one of the interface areas 6 (refer to FIG. 3) face each other, the portable terminal 1 and the sheetlike display terminal 2 are electrically connected to each other through the interface unit 7 and the interface unit 8 disposed in the interface area 6. The user can electrically connect the portable terminal 1 to the sheetlike display terminal 2 by merely putting the interface unit 7 on any interface unit 8.

FIGS. 4A and 4B illustrate an example of a state in which the portable terminal 1 and the sheetlike display terminal 2 are electrically connected to each other. In FIG. 4A, the portable terminal 1 is put on the sheetlike display terminal 2 in a state where the interface unit 7 and the interface unit 8a are put on each other. In this case, the sheetlike display terminal 2 is normally held vertically. Also, in FIG. 4B, the portable terminal 1 is put on the sheetlike display terminal 2 in a state where the interface unit 7 and the interface unit 8b are put on each other. In this case, the sheetlike display terminal 2 is normally held horizontally.

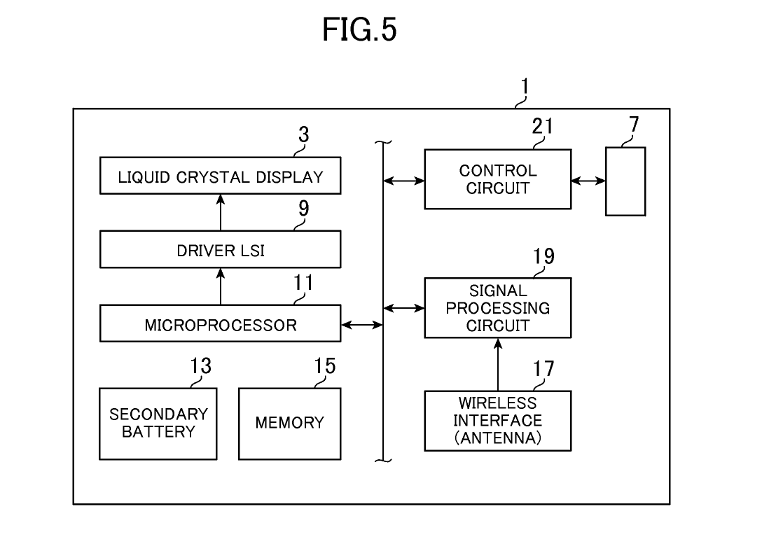

FIG. 5 is a configuration diagram illustrating components of the portable terminal 1. As illustrated in FIG. 5, the portable terminal 1 includes a driver LSI 9, a microprocessor 11, a secondary battery 13, a memory 15, a wireless interface 17, a signal processing circuit 19, and a control circuit 21 in addition to the liquid crystal display 3 and the interface unit 7. The microprocessor 11, the memory 15, the signal processing circuit 19, and the control circuit 21 are connected to a bus.

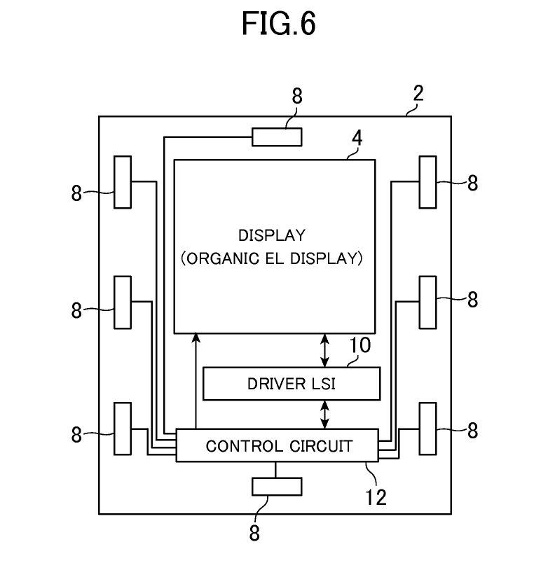

FIG. 6 is a configuration diagram illustrating components of the sheetlike display terminal 2. The sheetlike display terminal 2 includes a driver LSI 10 and a control circuit 12 in addition to the display 4 and the eight interface units 8. These components are disposed on a flexible substrate. However, the interface units 8 are disposed on a surface opposite to the other components. A configuration of the sheetlike display terminal 2 specializes in the display of an image, and is not equipped with a power supply device provided in the secondary battery 13, and a signal processing device provided in the signal processing circuit 19. For that reason, the sheetlike display terminal 2 is very lightweight, and excellent in portability.

The portable terminal 1 acquires, for example, an image to be streamed. That is, the wireless interface 17 that is an antenna receives an electric signal representing the image to be streamed, and the signal processing circuit 19 demodulates the electric signal, and outputs display data obtained by demodulation to the microprocessor 11.

Then, the portable terminal 1 allows the acquired image to be displayed on the liquid crystal display 3. That is, the portable terminal 1 first generates pixel data representing the acquired image. Specifically, the microprocessor 11 (generation unit) generates the pixel data from the display data received from the signal processing circuit 19 according to a program stored in the memory 15, and outputs the generated pixel data to the driver LSI 9. The pixel data includes a pixel value of each pixel. The portable terminal 1 allows the acquired image to be displayed on the liquid crystal display 3. Specifically, the driver LSI 9 allows the image represented by the pixel data to be displayed on the liquid crystal display 3 on the basis of the electric power supplied from the secondary battery 13.

When the portable terminal 1 and the sheetlike display terminal 2 are electrically connected to each other, the portable terminal 1 allows the acquired image to be displayed on the sheetlike display terminal 2. That is, the portable terminal 1 transmits the pixel data to the sheetlike display terminal 2 through the interface unit 7. Specifically, the control circuit 21 outputs a digital signal of the pixel data to the interface unit 7. Also, the portable terminal 1 transmits the electric power based on the secondary battery 13 to the sheetlike display terminal 2 through the interface unit 7. Specifically, the control circuit 21 transmits an electric power for allowing light emitting means (organic EL element in this example) provided in the display 4 to be lighted (hereinafter referred to as “lighting power”) to the sheetlike display terminal 2. Also, the control circuit 21 transmits an electric power for driving the respective pixels of the display 4 (hereinafter referred to as “driving power”) to the sheetlike display terminal 2.

In this way, when the portable terminal 1 and the sheetlike display terminal 2 are electrically connected to each other, the portable terminal 1 supplies the pixel data and the electric power to the sheetlike display terminal 2 through the interface unit 7. As described above, the user can electrically connect the portable terminal 1 to the sheetlike display terminal 2 by putting the interface unit 7 on any one of the interface units 8. Therefore, the user can view the image acquired in the portable terminal 1 by the aid of the sheetlike display terminal 2 with a simple work.

In the sheetlike display terminal 2, the pixel data and the electric power received through the interface unit 8 are input to the control circuit 12. The control circuit 12 and the driver LSI 10 (display control unit) allow the image represented by the pixel data to be displayed on the display 4 on the basis of the input electric power. That is, the control circuit 12 outputs the pixel data and the driving power to the driver LSI 10, and the driver LSI 10 converts the pixel value in the pixel data into the video signal on the basis of the driving power, and supplies the video signal to the respective pixels within the display 4. Also, the control circuit 12 applies a DC lighting voltage for lighting the light emitting means to the light emitting means provided in the display 4 on the basis of the lighting power.

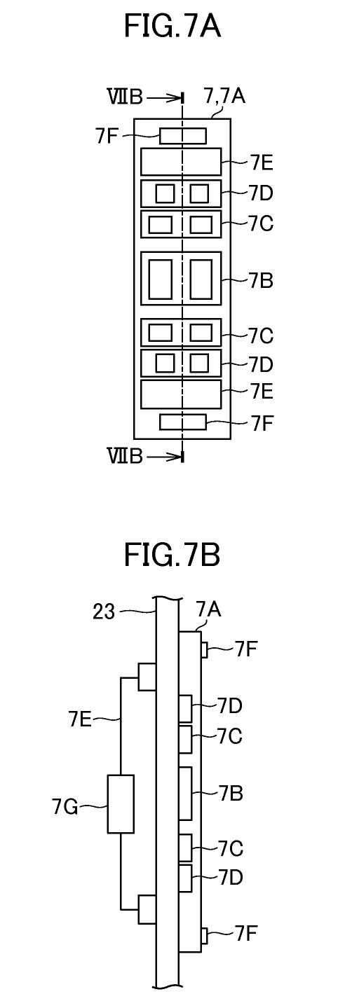

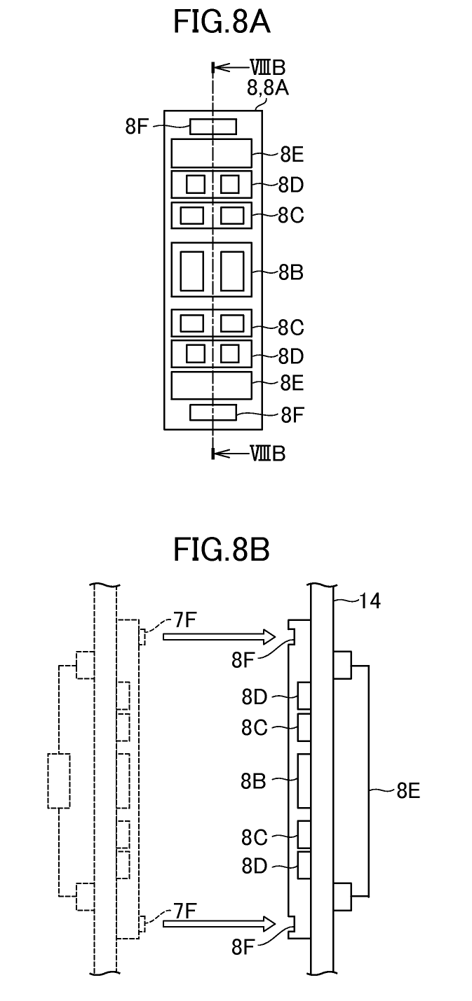

FIGS. 7A, 7B, 8A and 8B are diagrams illustrating configurations of the interface unit 7 and the interface units 8 for electrically connecting the portable terminal 1 to the sheetlike display terminal 2.

First, FIGS. 7A and 7B will be described. FIG. 7A is a diagram illustrating a configuration of the interface unit 7 provided in the portable terminal 1, and FIG. 7B is a cross-sectional view of the interface unit 7 taken along a line VIIB-VIIB. Reference numeral 23 denotes a wall of a housing of the portable terminal 1. A right side of the wall 23 is outside of the housing, and a left side of the wall 23 is inside of the housing. As shown in the figures, the interface unit 7 includes a lighting power transmission terminal 7B, two driving power transmission terminals 7C, and two signal transmitting and receiving terminals 7D. These terminals are covered with a protective insulating film 7A. The lighting power transmission terminal 7B is configured to transmit the lighting power. The lighting power is input to the lighting power transmission terminal 7B. The lighting power transmission terminal 7B is disposed in the center of the interface unit 7, and equipped with two electrodes. Also, the driving power transmission terminals 7C are configured to transmit the driving power. The driving power is input to the driving power transmission terminals 7C. The driving power transmission terminals 7C are each equipped with two electrodes. Also, the signal transmitting and receiving terminals 7D are configured to transmit and receive a signal. The above-mentioned pixel data is input to the signal transmitting and receiving terminals 7D. The signal transmitting and receiving terminals 7D are each equipped with two electrodes.

In this embodiment, the lighting power transmission terminal 7B is larger in size than the driving power transmission terminals 7C for the purpose of increasing a power rating. Also, in this embodiment, in order to increase a transfer rate of data, one of the signal transmitting and receiving terminals 7D is used for transmission of the signal, and the other signal transmitting and receiving terminal 7D is used for reception of the signal.

Also, the interface unit 7 includes magnetic members 7E inside the housing. The magnetic members 7E partially include an electromagnetic unit 7G for generating an attraction force between the interface unit 7 and the interface units 8. A coil is wound around the electromagnetic unit 7G.

Also, the interface unit 7 further includes two convex portions 7F on a surface of the protective insulating film 7A. A significance of the convex portions 7F will be described later.

Subsequently, FIGS. 8A and 8B will be described. FIG. 8A is a diagram illustrating a configuration of the interface unit 8 provided in the sheetlike display terminal 2, and FIG. 8B is a cross-sectional view of the interface unit 8 taken along a line VIIIB-VIIIB. Reference numeral 14 denotes a flexible substrate. As shown in FIGS. 8A and 8B, the interface unit 8 includes a lighting power receiving terminal 8B, driving power receiving terminals 8C, and signal transmitting and receiving terminals 8D. These terminals are covered with a protective film 8A that is an insulator. The lighting power receiving terminal 8B is configured to receive the lighting power. Also, the lighting power receiving terminal 8B is disposed in the center of the interface unit 8, and equipped with two electrodes. Also, the driving power receiving terminals 8C are configured to receive the driving power. The driving power receiving terminals 8C are each equipped with two electrodes. Also, the signal transmitting and receiving terminals 8D are configured to transmit and receive a signal. The signal transmitting and receiving terminals 8D are each equipped with two electrodes. Through the signal transmitting and receiving terminals 8D, for example, the pixel data is received, or for example, position coordinates at a position within the touch screen which is indicated by the user are transmitted.

Also, the interface units 8 each further include magnetic members 8E on a side opposite to the lighting power receiving terminal 8B. A magnetic force is generated between the magnetic members 7E and the magnetic members 8E due to the electromagnetic unit 7G.

Also, the interface units 8 further each include two concave portions 8F in the surface of the protective film 8A. The concave portions 8F are shaped in correspondence with a shape of the convex portions 7F. The respective convex portions 7F are fitted into the concave portions 8F whereby the portable terminal 1 is put on the sheetlike display terminal 2, and fixed. As a result, the portable terminal 1 and the sheetlike display terminal 2 are electrically connected to each other through the interface unit 7 and any interface unit 8. That is, a capacitor is formed by the lighting power transmission terminal 7B and the lighting power receiving terminal 8B, and the portable terminal 1 and the sheetlike display terminal 2 are connected to each other by capacitive coupling so as to enable the lighting power to be transmitted and received. Also, a capacitor is formed by each of the driving power transmission terminals 7C and the corresponding driving power receiving terminal 8C, and the portable terminal 1 and the sheetlike display terminal 2 are connected to each other by capacitive coupling so as to enable the driving power to be transmitted and received. Also, a capacitor is formed by each of the signal transmitting and receiving terminals 7D and the corresponding signal transmitting and receiving terminal 8D, and the portable terminal 1 and the sheetlike display terminal 2 are connected to each other by capacitive coupling so as to enable the signal to be transmitted and received.

The portable terminal 1 and the sheetlike display terminal 2 may be connected to each other by not the capacitive coupling, but electromagnetic coupling, so as to enable the signal to be transmitted and received. In this case, the signal transmitting and receiving terminals 7D and the signal transmitting and receiving terminals 8D have to include not the electrode, but a coil.

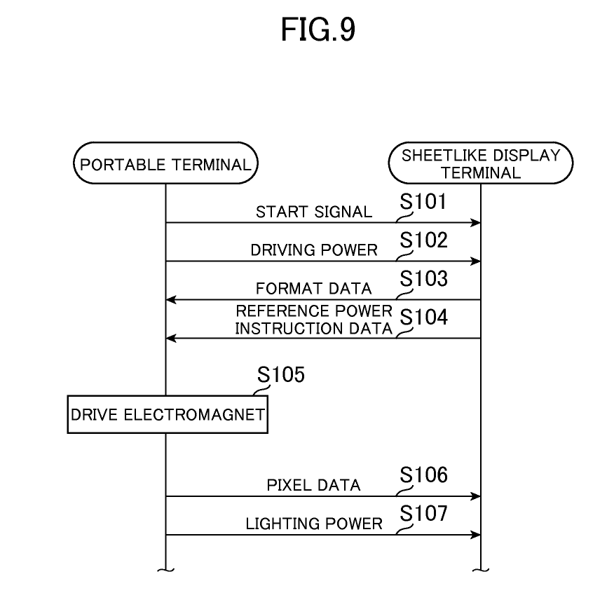

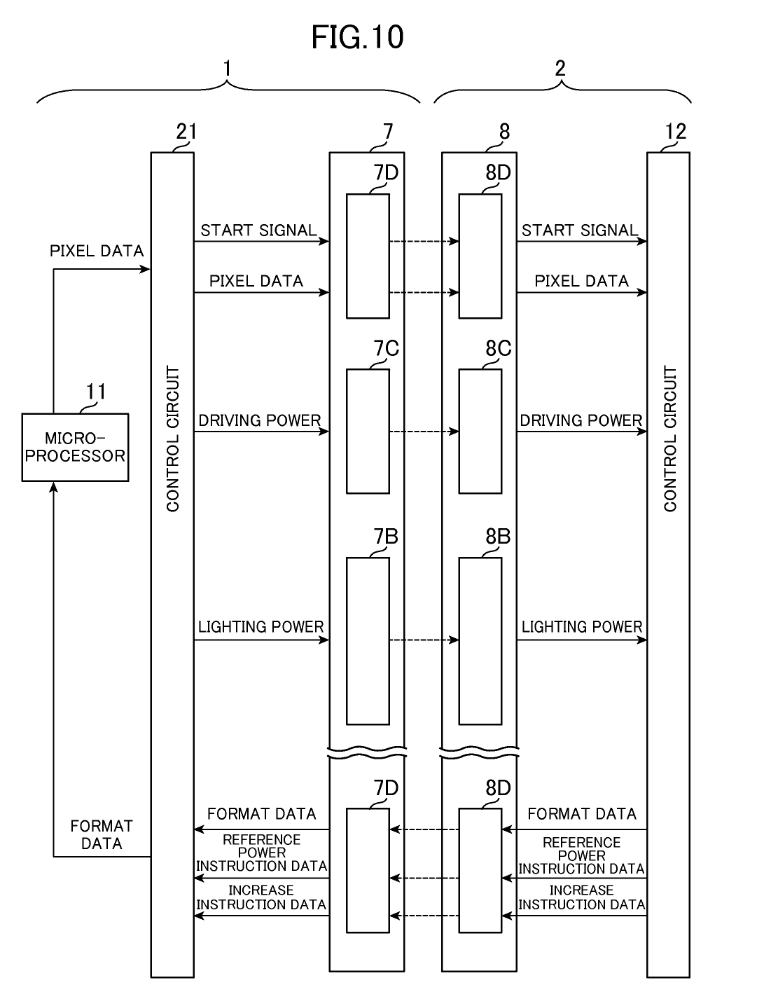

FIGS. 9 and 10 are diagrams illustrating the operation of the portable terminal 1 and the sheetlike display terminal 2 when the portable terminal 1 and the sheetlike display terminal 2 are electrically connected to each other. Hereinafter, the interface unit 8 put on the interface unit 7 is denoted by “interface unit 8X”.

First, the portable terminal 1 transmits a start signal for starting the sheetlike display terminal 2 to the sheetlike display terminal 2 through the signal transmitting and receiving terminals 7D (S101). Specifically, as illustrated in FIG. 10, the control circuit 21 (refer to FIG. 5) outputs the start signal to one of the signal transmitting and receiving terminals 7D. The start signal is received through one of the signal transmitting and receiving terminals 8D of the interface unit 8X (refer to FIG. 8A), and the sheetlike display terminal 2 comes to a start state.

Also, the portable terminal 1 starts to transmit the driving power to the sheetlike display terminal 2 (S102). Specifically, as illustrated in FIG. 10, the control circuit 21 (refer to FIG. 5) outputs the driving power to the driving power transmission terminal 7C on the basis of an electric power supplied from the secondary battery 13. The driving power is received through the driving power receiving terminal 8C of the interface unit 8X (refer to FIG. 8A), and input to the control circuit 12 (refer to FIG. 6).

Then, the sheetlike display terminal 2 that is in the start state transmits the format data representing a pixel format required for the image to be displayed on the display 4 to the portable terminal 1 through the other the signal transmitting and receiving terminals 8D of the interface unit 8X (S103). Specifically, as illustrated in FIG. 10, the control circuit 12 (refer to FIG. 6) outputs the digital signal of the format data to the signal transmitting and receiving terminal 8D of the interface unit 8X.

In this situation, the sheetlike display terminal 2 transmits format data corresponding to the interface unit 8 put on the interface unit 7. In more detail, if the interface unit 8X is the interface unit 8a (refer to FIG. 4A), the sheetlike display terminal 2 transmits format data A representing a pixel format A. If the interface unit 8X is the interface unit 8b (refer to FIG. 4B), the sheetlike display terminal 2 transmits the format data B representing a pixel format B. If the sheetlike display terminal 2 is held vertically (refer to FIG. 4A), the format data A is transmitted. Also, if the sheetlike display terminal 2 is held horizontally (refer to FIG. 4B), the format data B is transmitted.

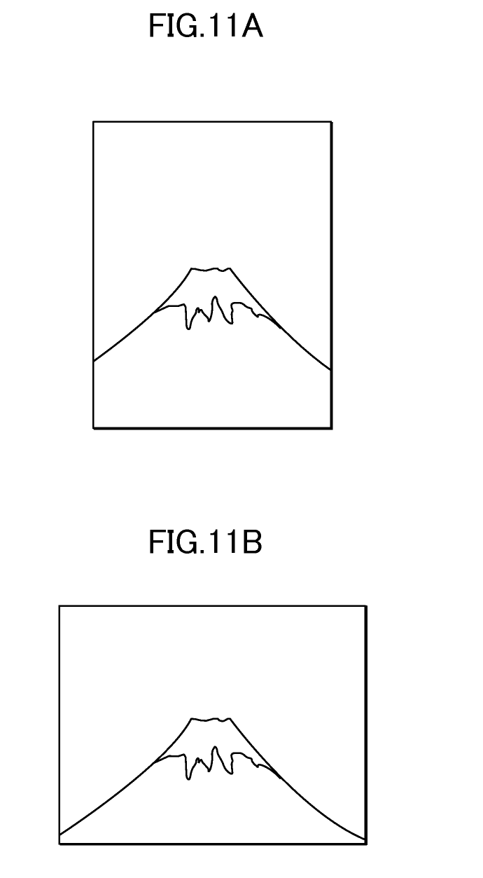

The format data received through the other signal transmitting and receiving terminal 7D is input to the microprocessor 11 through the control circuit 21. Hereinafter, the microprocessor 11 generates the pixel data in the pixel format represented by the format data. FIG. 11A illustrates the pixel data in the pixel format A, and FIG. 11B illustrates the pixel data in the pixel format B. As illustrated in FIGS. 11A and 11B, when the format data represents the pixel format A, the pixel data is generated in the vertically long pixel format. Also, when the format data represents the pixel format B, the pixel data is generated in the horizontally long pixel format. For that reason, an aspect ratio of the image is changed according to an orientation of the sheetlike display terminal 2.

If the format data is transmitted in S103, the sheetlike display terminal 2 transmits reference power instruction data instructing a reference power (the amount of electric power) necessary for turning on the light emitting means to the portable terminal 1 through the other signal transmitting and receiving terminal 8D of the interface unit 8X (S104). Specifically, as illustrated in FIG. 10, the control circuit 12 outputs the digital signal of the reference power instruction data to the signal transmitting and receiving terminal 8D of the interface unit 8X. The reference power is predetermined. The reference power instruction data is received through the other signal transmitting and receiving terminal 7D, and input to the control circuit 21.

Upon receiving the reference power instruction data, the portable terminal 1 drives the electromagnetic unit 7G (refer to FIGS. 7A and 7B) (S105). Specifically, the control circuit 21 supplies a drive current to the coil wound around the electromagnetic unit 7G. In this way, the portable terminal 1 generates the attraction force between the interface unit 7 and the interface unit 8X.

Then, the portable terminal 1 starts to transmit the pixel data to the sheetlike display terminal 2 (S106). Specifically, as illustrated in FIG. 10, the control circuit 21 outputs the digital signal of the generated pixel data to the signal transmitting and receiving terminal 7D every time the microprocessor 11 generates the pixel data. The pixel data is received through one of the signal transmitting and receiving terminal 8D of the interface unit 8X, and input to the control circuit 12.

Also, the portable terminal 1 starts to transmit the lighting power to the sheetlike display terminal 2 (S107). Specifically, as illustrated in FIG. 10, the control circuit 21 outputs the electric power of the amount corresponding to the reference power instructed by the reference power instruction data to the lighting power transmission terminal 7B as the lighting power on the basis of the electric power supplied from the secondary battery 13. The lighting power is received through the lighting power receiving terminal 8B of the interface unit 8X, and input to the control circuit 12. The control circuit 12 applies the lighting voltage to the light emitting means provided in the display 4 on the basis of the lighting power.

The lighting power transmitted from the portable terminal 1 is not always received without any loss. Under the circumstances, the control circuit 12 monitors whether the lighting voltage falls below a constant voltage necessary for turning on the light emitting means, or not, during lighting of the light emitting means. If the lighting voltage falls below the constant voltage, as illustrated in FIG. 10, the control circuit 12 outputs increase instruction data for instructing an increase in the amount of lighting power to the signal transmitting and receiving terminals 8D of the interface unit 8X. In this way, the control circuit 12 instructs the portable terminal 1 (precisely, the control circuit 21) to increase the lighting power, thereby making it possible that the lighting voltage does not fall below the given voltage.

As described above, in the image display system 100, the portable terminal 1 generates the pixel data, and supplies the pixel data and the electric power to the sheetlike display terminal 2. For that reason, the sheetlike display terminal 2 may not be equipped with the signal processing circuit 19 and the secondary battery 13. Therefore, that the image can be viewed with a larger screen to some degree can be realized with a smaller burden than that in a case to carry the portable terminal 1 and the portable terminal having a display having about the same size as that of the display 4. Also, in the image display system 100, the interface unit 7 is put on any one of the interface units 8 to electrically connect the portable terminal 1 to the sheetlike display terminal 2. For that reason, the user can electrically connect the portable terminal 1 to the sheetlike display terminal 2 with a simple work.

Also, in the image display system 100, the convex portions 7F are fitted to the respective concave portions 8F to allow the interface unit 7 to overlap with the interface units 8. For that reason, the position of the interface unit 7 can be prevented from being displaced from any interface unit 8. The convex portions 7F may be formed in the interface units 8, and the concave portions 8F may be formed in the interface unit 7.

Also, in the image display system 100, the attraction force is generated between the interface unit 7 and the interface units 8 due to the electromagnetic unit 7G. For that reason, the interface unit 7 and the interface units 8 can be prevented from being accidentally separated from each other. The electromagnetic unit 7G that generates the attraction force between the interface unit 7 and the interface units 8 may be provided in the interface units 8. Also, the electromagnetic unit 7G may be replaced with a permanent magnet.

The embodiments of the invention are not limited to the above embodiments.

For example, the display 4 provided in the sheetlike display terminal 2 may be a liquid crystal display. In this case, a backlight corresponds to the light emitting means.

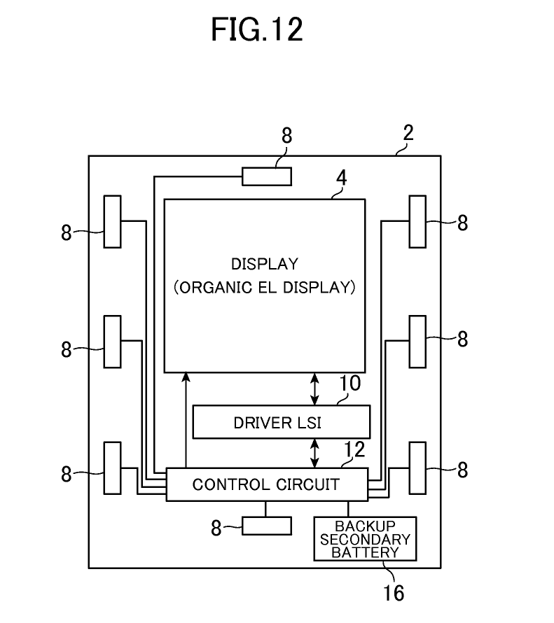

Also, for example, the sheetlike display terminal 2 may be equipped with a backup secondary battery (for example, thin film secondary battery) having a small capacity which stores the electric power received through the lighting power receiving terminal 8B. If the electric connection between the portable terminal 1 and the sheetlike display terminal 2 is canceled, the sheetlike display terminal 2 may apply the lighting voltage to the light emitting means on the basis of the electric power stored in the backup secondary battery. With the above configuration, if the electric connection between the portable terminal 1 and the sheetlike display terminal 2 is canceled, hold display can be conducted while the blackout is inhibited from being generated. FIG. 12 is a diagram illustrating this embodiment, which is a diagram illustrating components of the sheetlike display terminal 2 according to this embodiment. As shown in FIG. 12, the sheetlike display terminal 2 further includes a backup secondary battery 16. In this embodiment, while the portable terminal 1 and the sheetlike display terminal 2 are electrically connected to each other, the control circuit 12 outputs the lighting power received through the lighting power receiving terminal 8B to the backup secondary battery 16, and charges the backup secondary battery 16 with the lighting power. Under the circumstances, if the electric connection between the portable terminal 1 and the sheetlike display terminal 2 is canceled, the control circuit 12 can apply the lighting voltage to the light emitting means on the basis of the electric power stored in the backup secondary battery 16.

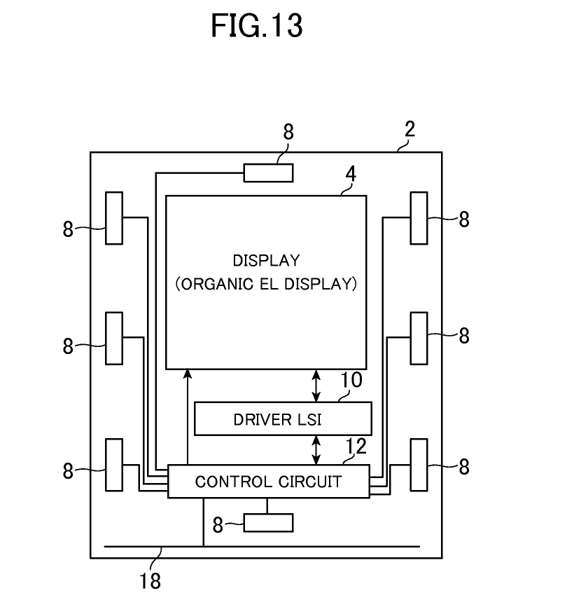

Also, for example, the image may be acquired by the sheetlike display terminal 2. That is, the sheetlike display terminal 2 may include an internal antenna. FIG. 13 is a diagram illustrating this embodiment, which is a diagram illustrating components of the sheetlike display terminal 2 according to this embodiment. As shown in FIG. 13, the sheetlike display terminal 2 further includes an internal antenna 18 connected to the control circuit 12. In this embodiment, the internal antenna 18 receives an electric signal representing an image streamed, and the control circuit 12 outputs the electric signal to the other signal transmitting and receiving terminal 8D, and transmits the electric signal to the portable terminal 1. In the portable terminal 1, the electric signal is input to the control circuit 21 through the signal transmitting and receiving terminal 7D, and the control circuit 21 outputs the electric signal to the signal processing circuit 19. Then, the electric signal is demodulated by the signal processing circuit 19, and the pixel data is generated by the microprocessor 11. In this embodiment, not only the wireless interface 17 (refer to FIG. 5) but also the internal antenna 18 is used for acquiring the image from the external. For that reason, more pieces of data can be received, and the streamed image can be more smoothly displayed.

While there have been described what are at present considered to be certain embodiments of the invention, it will be understood that various modifications may be made thereto, and it is intended that the appended claim cover all such modifications as fall within the true spirit and scope of the invention.

What is claimed is:

1. An image display system, comprising:
a portable terminal; and a sheetlike display terminal,
wherein the portable terminal includes:
a power supply;
a generation unit that generates pixel data representing an image to be displayed on the sheetlike display terminal; and
a first interface unit that is used for transfer of signal with respect to the sheetlike display terminal, and transmission of an electric power based on the power supply to the sheetlike display terminal,
wherein the portable terminal transfers the pixel data to the sheetlike display terminal through the first interface unit,
wherein the sheetlike display terminal includes:
a display unit that displays an image;
a second interface unit that is used for transfer of a signal with respect to the portable terminal, and reception of the electric power from the portable terminal; and
a display control unit that allows the image represented by the pixel data received through the second interface unit to be displayed on the display unit, on the basis of the electric power received through the second interface unit, and
wherein in a state where a first interface area corresponding to the first interface unit in a given surface of a housing of the portable terminal faces a second interface area corresponding to the second interface unit in a rear surface of an image display surface of the sheetlike display terminal, the portable terminal is put on the sheetlike display terminal so that the portable terminal and the sheetlike display terminal are electrically connected to each other through the first interface unit and the second interface unit.

2. The image display system according to claim 1,
wherein a convex portion is formed in one of the first interface area and the second interface area,
wherein a concave portion having a shape corresponding to a shape of the convex portion is formed in the other of the first interface area and the second interface area, and
wherein the convex portion is fitted into the concave portion so that the portable terminal is put on the sheetlike display terminal in a state where the first interface area faces the second interface area.

3. The image display system according to claim 1,
wherein the portable terminal and the sheetlike display terminal are connected to each other through the first interface unit and the second interface unit by capacitive coupling or electromagnetic coupling to enable the signal to be transferred therebetween.

4. The image display system according to claim 1,
wherein the portable terminal and the sheetlike display terminal are connected to each other through the first interface unit and the second interface unit by capacitive coupling to enable the electric power to be transferred therebetween.

5. The image display system according to claim 1,
wherein the portable terminal further includes a display that displays the image, and
wherein the given surface is the rear surface of the image display surface of the housing of the portable terminal.

6. The image display system according to claim 1,
wherein at least one of the first interface unit and the second interface unit includes an attraction generation unit that generates an attraction force between the first interface unit and the second interface unit.

7. The image display system according to claim 1,
wherein the sheetlike display terminal transmits format data representing a format required for the image to be displayed on the display unit to the portable terminal through the second interface unit, and
wherein the generation unit generates the pixel data on the basis of the format data received through the first interface unit.

8. The image display system according to claim 7,
wherein the sheetlike display terminal includes a plurality of the second interface units,
wherein in a state where the first interface area faces the second interface area corresponding to any one of the plurality of second interface units, the portable terminal is put on the sheetlike display terminal so that the portable terminal and the sheetlike display terminal are electrically connected to each other through the first interface unit and the any second interface unit, and
wherein the sheetlike display terminal transmits the format signal corresponding to the second interface area that faces the first interface area to the portable terminal.

9. The image display system according to claim 1,
wherein the sheetlike display terminal transmits data representing a reference power for allowing the image to be displayed on the display unit to the portable terminal through the second interface unit.

10. The image display system according to claim 9,
wherein the sheetlike display terminal further includes a monitor unit that monitors a voltage based on the electric power received through the second interface unit, and
wherein the sheetlike display terminal transmits data instructing a change in the amount of electric power to be transmitted, to the portable terminal through the second interface unit according to the monitoring result of the monitor unit.

11. The image display system according to claim 1,
wherein the sheetlike display terminal further includes a secondary battery that stores the electric power received through the second interface unit, and
wherein the display control unit allows the image represented by the pixel data to be displayed on the display unit on the basis of the electric power stored in the secondary battery if the electric connection between the portable terminal and the sheetlike display terminal is canceled.

12. A sheetlike display terminal having a display unit that displays an image, the sheetlike display terminal comprising:
a second interface unit that is used for receiving a data signal and an electric power from a portable terminal including a power supply, a generation unit that generates pixel data representing an image to be displayed on the sheetlike display terminal, and a first interface unit that is used for transmitting the pixel data and the electric power based on the power supply to the sheetlike display terminal; and
a display control unit that allows the image represented by the pixel data received through the second interface unit to be displayed on the display unit, on the basis of the electric power received through the second interface unit,
wherein in a state where a first interface area corresponding to the first interface unit in a given surface of a housing of the portable terminal faces a second interface area corresponding to the second interface unit in a rear surface of an image display surface of the sheetlike display terminal, the portable terminal is put on the sheetlike display terminal so that the sheetlike display terminal is electrically connected to the portable terminal through the first interface unit and the second interface unit.

13. A portable terminal comprising:
a power supply;
a generation unit that generates pixel data representing an image to be displayed on the sheetlike display terminal having a second interface unit used for receiving a signal and an electric power; and
a first interface unit that is used for transmitting the pixel data and an electric power based on the power supply to the sheetlike display terminal,
wherein in a state where a first interface area corresponding to the first interface unit in a given surface of a housing of the portable terminal faces a second interface area corresponding to the second interface unit in a rear surface of an image display surface of the sheetlike display terminal, the portable terminal is put on the sheetlike display terminal so that the portable terminal is electrically connected to the sheetlike display terminal through the first interface unit and the second interface unit.
